(19) United States
(12) Patent Application Publication
(10) Pub. No.: US 2011/0048652 A1
(43) Pub. Date: Mar. 3, 2011

(54) SAFETY MECHANISM FOR ROMAN SHADE

(75) Inventor: Ju-Huai Chen, Changhua County (TW)

(73) Assignee: MY HOME GLOBAL COMPANY, Changhua County (TW)

(21) Appl. No.: 12/611,623

(22) Filed: Nov. 3, 2009

(30) Foreign Application Priority Data
Aug. 25, 2009 (TW) 098215682

(51) Int. Cl. E06B 9/24

(52) U.S. Cl. 160/84.04

(57) ABSTRACT

A safety mechanism for Roman shade includes a shade assembly having a head rail, a shade cloth connected to the head rail, and connecting members set on the shade cloth; a lifting unit connected to the shade assembly and having pull cords and raising cords connected thereto; a plurality of butt-connecting devices connected to the pull cords and each having two detachably connected upper and lower sleeves; and a plurality of locking members associated with the raising cords and detachably engaged with the connecting members. When a pull cord or a raising cord is subjected to a load excessively larger than a force needed to lift or lower the shade cloth, the upper and lower sleeves of the butt-connecting device on that pull cord will separate from each other and the locking members on that raising cord will disengage from the connecting members, making the Roman shade safer for use.

### CROSS-REFERENCE TO RELATED APPLICATIONS

This non-provisional application claims priority under 35 U.S.C. §119(a) on Patent Application No(s). 098215682 filed in Taiwan, R.O.C. on 25 Aug. 2009, the entire contents of which are hereby incorporated by reference.

### FIELD OF THE INVENTION

The present invention relates to a safety mechanism for Roman shade, and more particularly to a safety mechanism for Roman shade that effectively prevents pull cords and raising cords of the Roman shade from endangering a small child.

### BACKGROUND OF THE INVENTION

A Roman shade is one of many commercially available window shades, and usually includes a head rail, a lifting unit, and a shade cloth connected to and hung from the head rail. The lifting unit includes a plurality of pull cords and raising cords, and the shade cloth can include a plurality of horizontal strips sequentially connected from top to bottom. At least one row of through holes is formed on the vertically sequentially connected horizontal strips for the raising cord to extend therethrough. A lower end of the raising cord is fixedly tied to the lowest one of the through holes. When the pull cords are pulled, the raising cords are raised or lowered to thereby bring the shade cloth to lift or lower.

The pull cords are usually located at one lateral side of the shade cloth and exposed to the open environment. A small child playing around in the room nearby the Roman shade might curiously or unexpectedly wind the pull cord or the raising cord around his or her neck and is subject to the risk of being dangerously strangulated by the cord. That is, the exposed pull cords and raising cords of the Roman shade form a big potential threat to the safety of small children.

It is therefore desirable and tried by the inventor to develop a safety mechanism for Roman shade, so that the Roman shade is safer for use.

### SUMMARY OF THE INVENTION

A primary object of the present invention is to provide a safety mechanism for Roman shade capable of preventing pull cords and raising cords of the Roman shade from winding around and endangering a small child, so that the Roman shade is safer for use.

To achieve the above and other objects, the safety mechanism for Roman shade according to the present invention includes a shade assembly having a head rail, a shade cloth connected at an end to the head rail, and a plurality of connecting members provided on the shade cloth; a lifting unit connected to the shade assembly and having pull cords and raising cords connected thereto; a plurality of butt-connecting devices separately connected to the pull cords and each having two detachably connected upper and lower sleeves; and a plurality of locking members associated with the raising cords and detachably engaged with the connecting members.

When a pull cord or a raising cord is subjected to a load excessively larger than a force needed to lift or lower the shade cloth, such as when a small child is wound around by and struggling against the cord, the upper and lower sleeves of the butt-connecting device on that pull cord will separate from each other and the locking members on that raising cord will disengage from the connecting members to release the child from the cord, making the Roman shade safer for use.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view showing a safety mechanism for Roman shade according to a first embodiment of the present invention;

FIG. 2 is an exploded perspective view of a butt-connecting device adopted in the safety mechanism for Roman shade of the present invention;

FIG. 3 is a perspective view of a locking member adopted in the safety mechanism for Roman shade of the present invention;

FIG. 4 shows the state of the safety mechanism for Roman shade of FIG. 1 when any one of a plurality of pull cords and raising cords is subjected to an excessively heavy load; and

FIG. 5 is a perspective view showing a safety mechanism for Roman shade according to a second embodiment of the present invention.

### DETAILED DESCRIPTION OF THE PREFERRED EMBODIMENTS

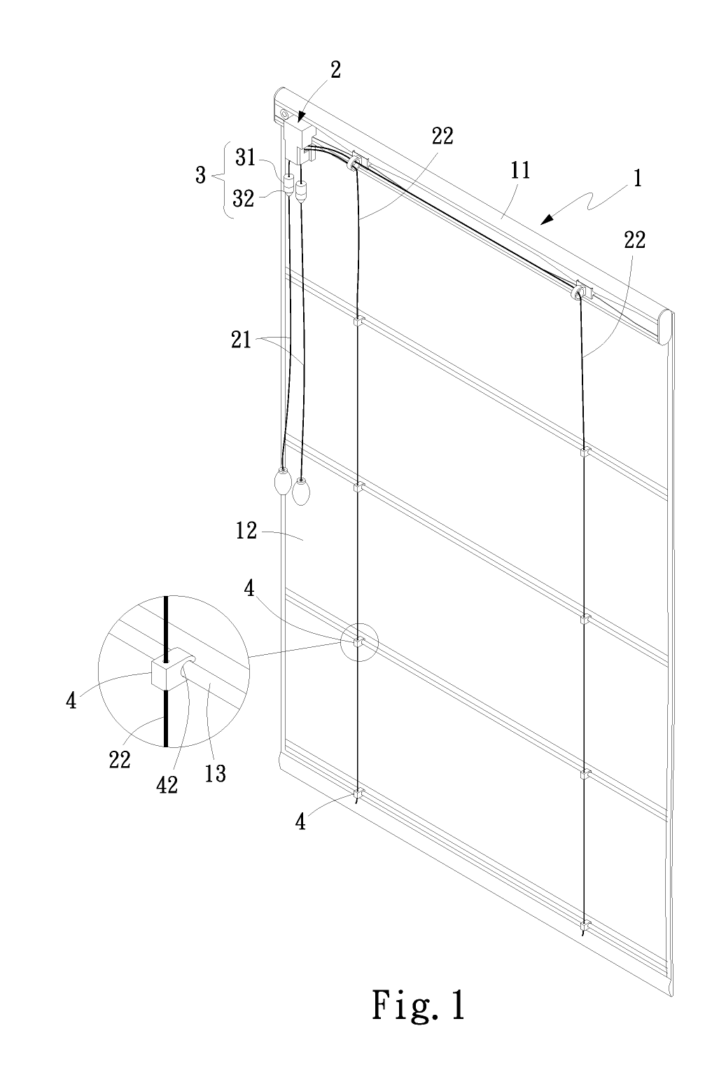

Please refer to FIG. 1 that is a perspective view showing a safety mechanism for Roman shade according to a first embodiment of the present invention. As shown, the safety mechanism for Roman shade shown in FIG. 1 includes a shade assembly 1, a lifting unit 2, a plurality of butt-connecting devices 3, and a plurality of locking members 4.

The shade assembly 1 includes a head rail 11, a shade cloth 12 connected at an upper end to the head rail 11, and a plurality of connecting members 13 connected to the shade cloth 12. The connecting members 13 each can be in the form of a transverse bar extended across a full width of the shade cloth 12.

The lifting unit 2 is connected to the shade assembly 1, and has a plurality of pull cords 21 and a plurality of raising cords 22 connected thereto.

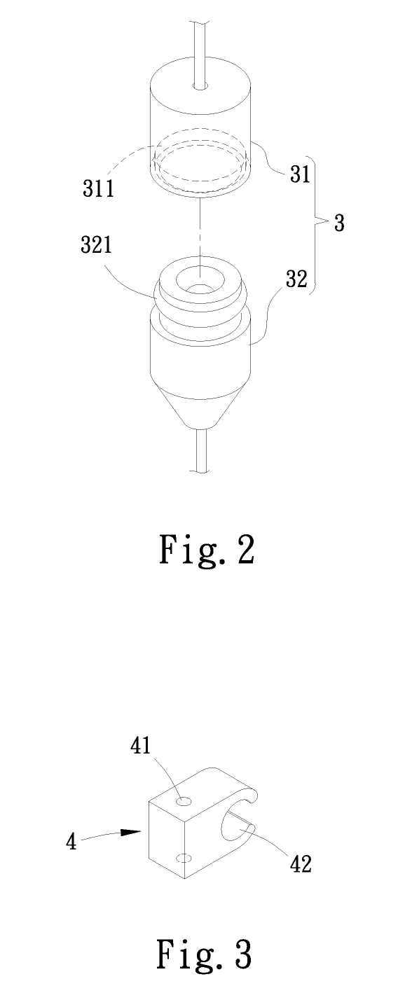

The butt-connecting devices 3 are separately connected to the pull cords 21. As can be seen from FIG. 2, each of the butt-connecting devices 3 includes an upper sleeve 31 and a lower sleeve 32 detachably connected to the upper sleeve 31. The upper sleeve 31 is internally provided around a lower end thereof with an annular groove 311, and the lower sleeve 32 is externally provided around an upper end thereof with an annular rib 321 for fitly engaging with the annular groove 311. Alternatively, the upper sleeve 31 is internally provided around the lower end thereof with an annular rib (not shown), and the lower sleeve 32 is externally provided around the upper end thereof with an annular groove (not shown) for fitly engaging with the annular rib in the upper sleeve 31.

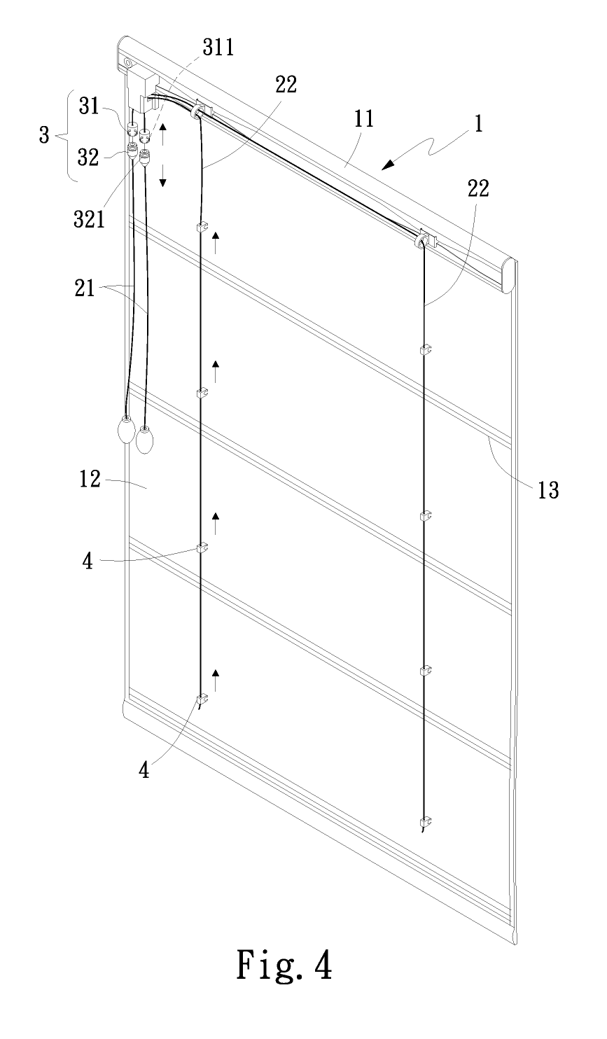

The locking members 4 are associated with the raising cords 22 and detachably connected to the connecting members 13. Please refer to FIG. 4. Each of the locking members 4 is provided near an end with a vertically extended bore 41, through which one raising cord 22 is extended to thereby associate with the locking member 4. The locking member 4 is provided at an opposing end with a horizontally extended locking groove 42 for detachably engaging with the connecting member 13.

Please refer to FIG. 4 along with FIGS. 2 and 3. When the pull cords 21 are pulled, the butt-connecting members 3 on the pull cords 21 are brought to move along with the pull cords 21; meanwhile, through the action of the lifting unit 2, the raising cords 22 and the locking members 4 associated therewith are raised or lowered by the pulled pull cords 21 to accordingly, lift or lower the shade cloth 12 connected to the locking members and the raising cords 22 via the connecting members 13.

In the event a small child playing around in a room curiously or unexpectedly winds any one of the pull cords 21 or the raising cords 22 around one part of his or her body, such as the neck, and the pull cord 21 or the raising cord 22 winding around the small child is subjected to a load excessively larger than the pull force needed to raise the shade cloth 12, the upper and the lower sleeve 31, 32 of the butt-connecting device 3 on the excessively loaded pull cord 21 will become separated from each other at the annular groove 311 and the annular rib 321, and the locking grooves 41 of the locking members 4 on the excessively loaded raising cord 22 will become disengaged from the connecting members 13, as shown in FIG. 4, so that the pull cord 21 or the raising cord 22 no longer tightly winds around the small child's body to endanger the child. When the dangerous condition is removed, the separated upper and lower sleeves 31, 32 can be connected to each other again by engaging the annular groove 311 with the annular rib 321, and the locking members 4 can be connected to the shade cloth 12 by engaging the locking grooves 41 with the connecting members 13 again. Thus, the pull cord 21 and the raising cord 22 can work again to lift or lower the shade cloth 12.

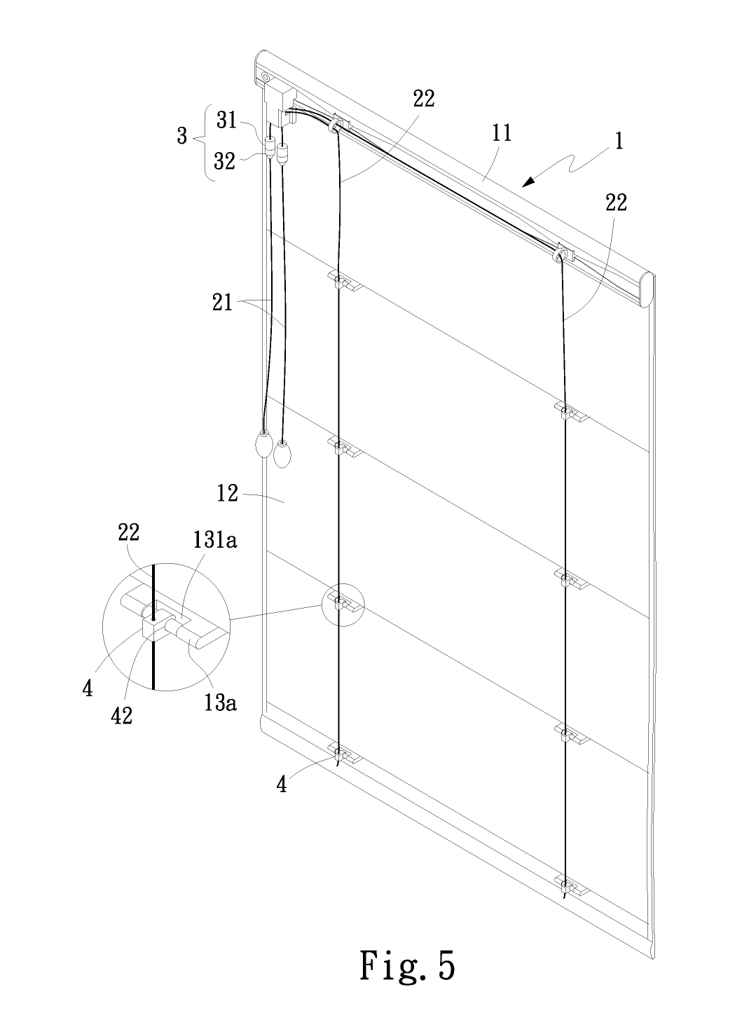

FIG. 5 shows a second embodiment of the present invention, which is generally structurally similar to the first embodiment, except for a plurality of connecting members 13a each being in the form of a holding seat sewn to predetermined positions on the shade cloth 12. Each of the connecting members 13a is provided at one edge opposite to the shade cloth 12 with an engaging bar 131a, with which the locking groove 41 on the locking member 4 is detachably engaged. Therefore, the second embodiment can provide the same safety effect as the first embodiment.

In the present invention, whenever the pull cord 21 or the raising cord 22 is subjected to a load excessively larger than a force needed to lift or lower the shade cloth of a Roman shade, the upper and lower sleeves of the butt-connecting member on the overloaded pull cord will become separated from each other and the locking member on the overloaded raising cord will disengage from the connecting member to avoid the cord from entangling with or strangulating a child, making the Roman shade safer for use. Therefore, the safety mechanism for Roman shade according to the present invention is novel, improved, and practical for use to fully satisfy the market demands.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A safety mechanism for Roman shade, comprising:
a shade assembly including a head rail, a shade cloth connected at an upper end to the head rail, and a plurality of connecting members provided on the shade cloth at predetermined positions;
a lifting unit being connected to the shade assembly, and having a plurality of pull cords and a plurality of raising cords connected thereto;
a plurality of butt-connecting devices being separately connected to the pull cords; and each of the butt-connecting devices including an upper sleeve and a lower sleeve detachably connected to each other; and
a plurality of locking members being associated with the plurality of raising cords and detachably engaged with the connecting members.

2. The safety mechanism for Roman shade as claimed in claim 1, wherein each of the connecting members is in the form of a transverse bar extended across the shade cloth.

3. The safety mechanism for Roman shade as claimed in claim 1, wherein each of the connecting members is in the form of a holding seat, and is provided at an edge opposite to the shade cloth with an engaging bar, with which the locking member is detachably engaged.

4. The safety mechanism for Roman shade as claimed in claim 1, wherein the upper sleeve is provided around a lower end thereof with an annular groove or an annular rib, and the lower sleeve is provided around an upper end thereof with an annular rib or an annular groove corresponding to the annular groove or the annular rib, respectively, on the upper sleeve.

5. The safety mechanism for Roman shade as claimed in claim 1, wherein each of the locking members is provided at one end with a bore for the raising cord to extend therethrough, and at another opposing end with a locking groove for detachably engaging with the connecting member.
